(19) United States
(12) Patent Application Publication
(10) Pub. No.: US 2017/0255879 A1
(43) Pub. Date: Sep. 7, 2017

(54) SEARCHING METHOD AND DEVICE BASED ON ARTIFICIAL INTELLIGENCE

(71) Applicant: Beijing Baidu Netcom Science And Technology Co., Ltd., Beijing (CN)

(72) Inventors: Li CHEN, Beijing (CN); Qian XU, Beijing (CN); Hao TIAN, Beijing (CN); Jingzhou HE, Beijing (CN); Lei SHI, Beijing (CN); Fan WANG, Beijing (CN); Shiwei HUANG, Beijing (CN); Derong ZHENG, Beijing (CN)

(21) Appl. No.: 15/392,017

(22) Filed: Dec. 28, 2016

(30) Foreign Application Priority Data
Mar. 1, 2016 (CN) 201610115420.3

(51) Int. Cl. G06N 99/00; G06F 17/30

(52) U.S. Cl. CPC G06N 99/005; G06F 17/30979; G06F 17/30994

(57) ABSTRACT

A searching method and device based on artificial intelligence is provided in the present disclosure. The searching method includes: obtaining a query; obtaining a first search result corresponding to the query according to a Markov Decision Process MDP model; displaying the first search result; and obtaining a reward for the first search result from a user so as to obtain a second search result according to the MDP model, and displaying the second search result. According to the searching method, the interaction with the user may be more effective, the user's demand is better satisfied, and the user experience is improved.

### RELATED APPLICATIONS

This application claims benefit of priority to Chinese Patent Application Number 201610115420.3, filed Mar. 1, 2016, which is incorporated herein by reference in its entirety.

### FIELD

The present disclosure relates to internet technology field.

### BACKGROUND

Artificial Intelligence (AI for short) is a new technology science studying and developing theories, methods, techniques and application systems for simulating, extending and expanding human intelligence. The AI is a branch of computer science, which attempts to know the essence of intelligence and to produce an intelligent machine capable of acting as a human. Research in the field includes robots, speech recognition, image recognition, natural language processing and expert systems, etc.

As an importance application of the Internet, the search engine aims to display information required by a user to the user. The existing search system calls back a series of static results by only using keywords provided by the user as an index. However, in an actual application, a demand of the user is usually represented as a series of processes, and if the demand of the user has a horizontal or a longitudinal expanding, the existing search system cannot have a real interaction with the user.

### SUMMARY

The present disclosure seeks to solve at least one of the problems existing in the related art to at least some extent.

For this, according to a first aspect of embodiments of the present disclosure, a searching method based on artificial intelligence is proposed. The searching method includes: obtaining a query; obtaining a first search result corresponding to the query according to a MDP (Markov Decision Process) model; displaying the first search result; and obtaining a reward for the first search result from a user so as to obtain a second search result according to the MDP model, and displaying the second search result.

According to a second aspect of embodiments of the present disclosure, a searching device based on artificial intelligence is proposed. The searching device includes one or more computing devices configured to execute one or more software modules, the one or more software modules including: an obtaining module, configured to obtain a query; a calculating module, configured to obtain a first search result corresponding to the query according to a MDP model; a displaying module, configured to display the first search result; and a reward module, configured to obtain a reward for the first search result from a user, such that a second search result is obtained according to the MDP model, and the second search result is displayed.

According to a third aspect of embodiments of the present disclosure, a non-transitory computer readable storage medium is provided. The storage medium has stored therein instructions that, when executed by a processor of a terminal, cause the terminal to perform a searching method described above.

With the present disclosure, multiple interactions may be performed with the user, such that the interaction with the user is more effective, and moreover, by obtaining the search result according to the MDP model, the user's demand is better satisfied, and the user experience is improved.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The above-described and/or other aspects and advantages of embodiments of the present disclosure will become apparent and more readily appreciated from the following descriptions made with reference to the drawings, in which:

FIG. 1 is a flow chart of a searching method based on artificial intelligence according to an embodiment of the present disclosure;

FIG. 2 is a flow chart of a searching method based on artificial intelligence according to another embodiment of the present disclosure; and

FIG. 3 is a block diagram of a searching device based on artificial intelligence according to an embodiment of the present disclosure.

### DETAILED DESCRIPTION

Reference will be made in detail to embodiments of the present disclosure, so as to make objectives, technical solutions and advantages of the present disclosure clearer. It should be understood that, embodiments described herein are only used to explain the present disclosure, but not used to limit the present disclosure. In addition, it should be noted that, for sake of description, part of content related to the present disclosure is illustrated in the drawings, but not all the content.

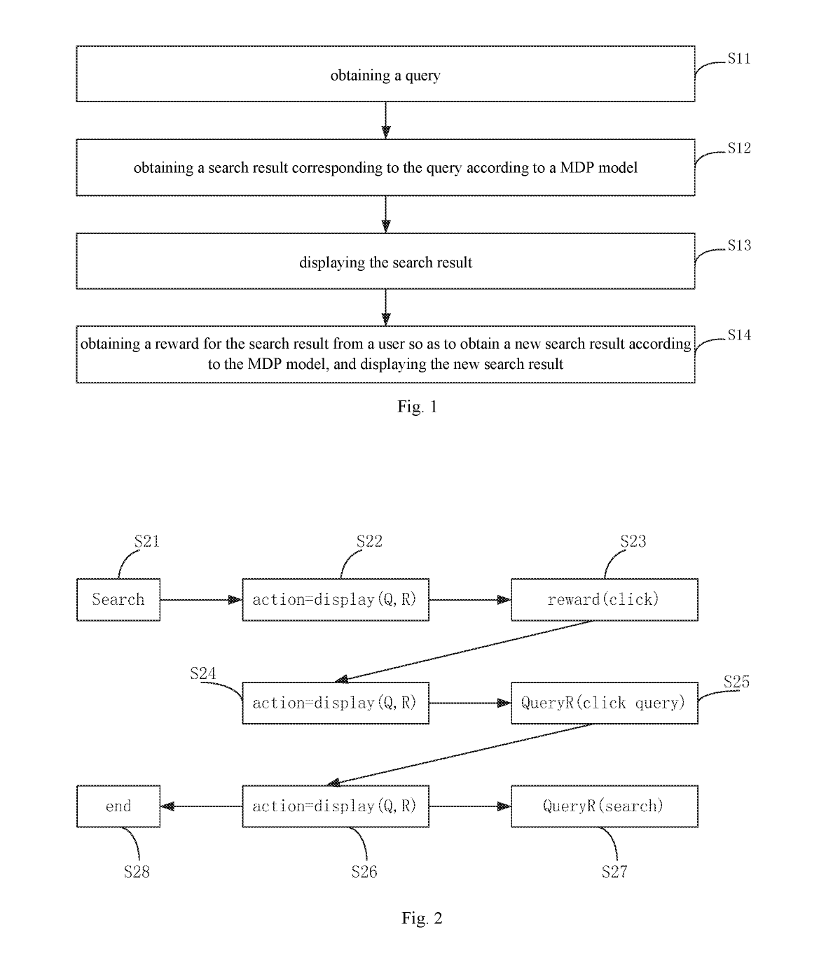

FIG. 1 is a flow chart of a searching method based on artificial intelligence according to an embodiment of the present disclosure. Referring to FIG. 1, the searching method includes steps as follows.

In step S11, a query is obtained.

Initially, a user may input the query and start a search, such that a search engine may receive the query inputted by the user.

The user may input the query in a form of text, audio or picture.

In step S12, a search result corresponding to the query is obtained according to a Markov Decision Process MDP model.

In the present embodiment, based on a “Reinforcement Learning” technology in machine learning technology, the searching problem is regarded as a Markov Decision Process (MDP).

The MDP model is represented using a triple as follows: a state, an action, and a reward.

The MDP solves the action A, one of the solving methods is to choose the action that maximizes a profit value, which is represented by a formula as:

A=arg max_{A}{Q(S,A)} (1),
the formula represents: solving the A that maximizes the value of Q,
where, Q is a profit function regarding to S and A, S is the state, and A is the action.

The form of function Q is determined by R (the reward), for example, the function form of Q is determined by solving R=Q(S,A). Specifically, Q may be further represented as Q(S, A)=sum(r0+r1+r2+. . . ), r0, r1, r2 . . . is a profit value of each step, and Q(S,A) is obtained by temporal difference learning.

Initially, when the user has not made a reward, the reward is null, and thus the value of R may be represented by 0.

The above method of solving A uses a strategy in which the profit value is maximized, which is usually called as Greedy. However, other solving methods may also be used, for example, an Explore & Exploit method is used. The Explore & Exploit method is characterized by not choosing the best strategy every time, but choosing a second best or an uncertain strategy (the strategy may be good or not good) at a certain probability, including ε-greedy, softmax, and sampling.

In the present embodiment, when the MDP model is introduced into the searching, the above triples of the MDP model are specifically described as follows.

S=state=query+context, in which, the query+context is corresponding to the current state. Taking the query as an example, the query may be different in different states. For example, according to different states, the query may be a query inputted by the user (e.g. when the user initially starts the query), the query recommended by the search engine to the user (e.g. when the user clicks the recommended query), the query after switching by the user (e.g. when the user restarts the query if the user is not satisfied with the search result). In addition, the context includes, for example, recent actions of the user, and a browsing record, etc.

A=action=search result=display (Query, R), in which, R is a webpage result in a common format, and is configured to satisfy the user's demand directly; and Query is a query recommended by the search engine to the user, and is configured to guide and motivate the user. The webpage result in the common format is, for example, a webpage link displayed on a PC terminal, or a result displayed on the mobile terminal in a form of cards. The query corresponding to A may be determined by formula (1).

R=reward=a user action caused by the user according to the displayed search result, for example, including: a clicking and buying action of the user (e.g. shopping information of a merchandise is displayed in the search result, and the user buys the merchandise according to the shopping information), a staying duration on a corresponding webpage after the user clicks a certain result to enter the webpage (i.e. a clicking duration), a staying duration of the user in the entire search process (i.e. a searching duration), clicking the search result (a webpage result and/or a query recommended to the user) by the user, and the switched query inputter by the user etc.

Therefore, using the above S, A, R in the search process and the above formula (1), A corresponding to the query may be obtained, which is the query result corresponding to the query.

In step S13, the search result is displayed.

After the search engine obtains the search result, the search result may be sent to the client terminal for displaying.

In step S14, a reward for the search result is obtained so as to obtain a new search result according to the MDP model, and the new search result is displayed.

A common search process is an interaction process, and in the present embodiment, the user may perform multiple interactions with the search engine, and the search engine may adjust the search result according to the reward of the user during the multiple interactions.

For example, referring to FIG. 2, the search process including the multiple interactions may include steps as follows.

In step S21, the user starts a search.

For example, the user inputs an initial query, and the search may be started after the user clicks the search button.

In step S22, the search engine calculates the search result according to the MDP model, and displays the search result.

The search result is represented by action=display(Query, R).

The A (action) corresponding to the current query may be calculated by using formula (1). Initially, when there is no reward, the reward is regarded as null.

In step S23, a first reward of the user is received.

Taking clicking a certain webpage result by the user as an example, the first reward is represented as reward (click) in the drawings.

In step S24, the search result is re-calculated and displayed.

The search result is represented by action=display(Query, R).

The A (action) corresponding to the current query may be calculated using formula (1), where the reward uses the above-described first reward.

In step S25, a second reward of the user is received.

Taking clicking the recommended query by the user as an example, the second reward is represented as QueryR (click query) in the drawings.

In step S26, the search result is re-calculated and displayed.

The search result is represented by action=display(Query, R).

The A (action) corresponding to the current query may be calculated using formula (1), where the reward uses the above-described second reward.

After this, step S27 or S28 may be executed.

In step S27, a third reward of the user is received.

Taking clicking the switched query inputted by the user as an example, the third reward is represented as QueryR (search) in the drawings.

For example, after the user obtains the search result, he may neither click the webpage result nor click the recommended query, but re-input a new query.

Then, the search engine may re-calculate the search result and display the re-calculated search result.

The search result is represented by action=display(Query, R).

The A (action) corresponding to the current query may be obtained using formula (1), where the reward uses the above-described third reward.

In step S28, the process ends.

For example, after the user obtains the search result, a following search may not be executed, and the search process is over.

In the above description, three rewards are taken as examples. It could be understood that, in an actual search process, the rewards executed by the user are not limited to the above-described three rewards, i.e. the user may execute one or two of the above-described rewards or execute other rewards. In addition, the number of interactions is not limited to three, a different number of interactions may also be executed, and different or same rewards may be used in different interactions.

In the present embodiment, by obtaining the rewards of the user, multiple interactions may be performed with the user, such that more efficient interactions may be performed with the user. In addition, by calculating the search result using the MDP model, the user's demand may be better satisfied, and the user experience may be improved. Further, by regarding the searching duration as one kind of reward, since the determination of the action is related to the reward, the searching duration may be regarded as an optimization objective, such that it is convenient for the user to stay longer in a conversation of the search. By including the webpage result and the recommended query in the search result, satisfying the user and guiding the user may be considered as a whole. According to the above rewards, multidirectional and interleaved guidance and satisfaction such as query-item, query-query and item-query may be built, such that a closed-loop in the searching ecology can be built effectively. By guiding and motivating the user and adjusting the search result according to the rewards, the user's demand can be clarified horizontally and vertically, and more attention may be paid on the entire searching process rather than calling a single query.

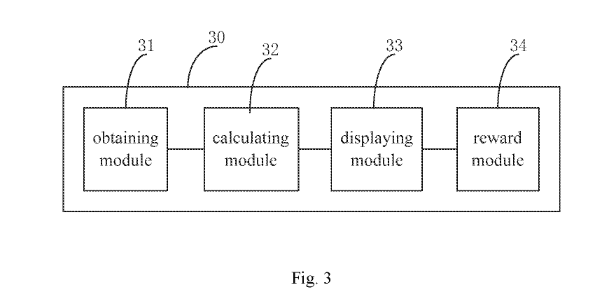

FIG. 3 is a block diagram of a searching device based on artificial intelligence according to an embodiment of the present disclosure. Referring to FIG. 3, the searching device 30 includes: an obtaining module 31, a calculating module 32, a displaying module 33 and a reward module 34.

The obtaining module 31 is configured to obtain a query.

Initially, the user may input the query and start a search, such that the search engine may receive the query inputted by the user.

The user may input the query using a form of text, audio and picture.

The calculating module 32 is configured to obtain a search result corresponding to the query according to a Markov Decision Process MDP model.

In the present embodiment, based on a “Reinforcement Learning” technology in machine learning technology, the searching problem is regarded as a Markov Decision Process (MDP).

The MDP model is represented using a triple as follows: a state, an action, and a reward.

The MDP solves the action A, one of the solving methods is to choose the action that maximizes a profit value, which is represented by formula (1).

In some embodiments, parameters of the MDP model used in the calculating module 32 include:
a state, represented by the query and a context;
an action, represented by the search result; and
a reward, representing by the reward for the search result of the user.

In some embodiments, the query includes:
a query inputted by the user initially, a query recommended to the user, or a switched query inputted by the user.

In some embodiments, the search result includes:
a webpage result, and a query recommended to the user.

The reward includes one or more of following items:
clicking the webpage result by the user;
clicking the query recommended to the user by the user;
the switched query inputted by the user;
a clicking and buying action of the user;
a clicking duration; and
a searching duration.

The specific calculation process may refer to a description in the method embodiments, which shall not be elaborated herein.

The displaying module 33 is configured to display the search result.

After the search result is obtained by the search engine, it may be sent to the client for displaying.

The reward module 34 is configured to obtain a reward for the search result, such that a new search result is obtained according to the MDP model and the new search result is displayed.

A common search process is an interaction process, and in the present embodiment, the user may perform multiple interactions with the search engine, and the search engine may adjust the search result according to the user's reward during the multiple interactions.

A search process containing multiple rounds may refer to FIG. 2, which shall not be elaborated herein.

It should be understood that, the device embodiment is corresponding to the above method embodiment, and the specific content may refer to the related description in the method embodiment, which shall not be elaborated herein.

In the present embodiment, multiple interactions may be performed with the user by obtaining the user's reward, such that a more efficient interaction may be performed with the user, in addition, by calculating the search result using the MDP model, the user's demand may be better satisfied, and the user experience may be improved.

It should be noted that, in the description of the present disclosure, terms such as “first” and “second” are used herein for purposes of description and are not intended to indicate or imply relative importance or significance. In addition, in the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A searching method based on artificial intelligence, comprising:
obtaining a query;
obtaining a first search result corresponding to the query according to a Markov Decision Process (MDP) model;
displaying the first search result; and
obtaining a reward for the first search result from a user so as to obtain a second search result according to the MDP model, and displaying the second search result.

2. The searching method according to claim 1, wherein, parameters of the MDP model comprise:
a state, represented by the query and a context;
an action, represented by the first search result; and
a reward, represented by the reward for the first search result.

3. The searching method according to claim 1, wherein, the query comprises:
a query inputted by the user initially, a query recommended to the user, or a switched query inputted by the user.

4. The searching method according to claim 1, wherein, the first search result comprises:
a webpage result, and a query recommended to the user.

5. The searching method according to claim 4, wherein, the reward comprises one or more of:
clicking the webpage result by the user;
clicking the query recommended to the user by the user;
the switched query inputted by the user;
a clicking and buying action of the user;
a clicking duration; and
a searching duration.

6. A searching device based on artificial intelligence, comprising:
one or more computing devices configured to execute one or more software modules, the one or more software module comprising:
an obtaining module, configured to obtain a query;
a calculating module, configured to obtain a first search result corresponding to the query according to a Markov Decision Process (MDP) model;
a displaying module, configured to display the first search result; and
a reward module, configured to obtain a reward for the first search result from a user, such that a second search result is obtained according to the MDP model and the second search result is displayed.

7. The searching device according to claim, 6, wherein, parameters of the MDP model used in the calculating module comprise:
a state, represented by the query and a context;
an action, represented by the first search result; and
a reward, represented by the reward for the first search result.

8. The searching device according to claim 6, wherein the query comprises:
a query inputted by the user initially, a query recommended to the user, or a switched query inputted by the user.

9. The searching device according to claim 6, wherein, the first search result comprises:
a webpage result, and a query recommended to the user.

10. The searching device according to claim 9, wherein, the reward comprises one or more of:
clicking the webpage result by the user;
clicking the query recommended to the user by the user;
the switched query inputted by the user;
a clicking and buying action of the user;
a clicking duration; and
a searching duration.

11. A non-transitory computer readable storage medium having stored therein instructions that, when executed by a processor of a terminal, causes the terminal to perform a searching method based on artificial intelligence, the searching method comprising:
obtaining a query;
obtaining a first search result corresponding to the query according to a Markov Decision Process (MDP) model;
displaying the first search result; and
obtaining a reward for the first search result from a user so as to obtain a second search result according to the MDP model, and displaying the second search result.
